(19) United States
(12) Patent Application Publication
(10) Pub. No.: US 2022/0318063 A1
(43) Pub. Date: Oct. 6, 2022

(54) NEED-BASED RESOURCE SYNCHRONIZATION IN MULTI-NODE DATA PIPELINES AND SAMPLING METRICS OF A DATA PIPELINE

(71) Applicant: Meta Platforms, Inc., Menlo Park, CA (US)

(72) Inventor: Hamilton Greene, New York, NY (US)

(21) Appl. No.: 17/710,816

(22) Filed: Mar. 31, 2022

Related U.S. Application Data
(60) Provisional application No. 63/169,072, filed on Mar. 31, 2021.

(51) Int. Cl. G06F 9/50; G06F 9/48

(52) U.S. Cl. CPC G06F 9/505; G06F 9/4881; G06F 9/5055; G06F 9/5077

(57) ABSTRACT

Methods, systems, and storage media for need-based resource synchronization in multi-node data pipelines are disclosed. In addition, methods, systems, and storage media for sampling metrics of a data pipeline are disclosed.

### TECHNICAL FIELD

The present disclosure generally relates to managing data pipelines, and more particularly to need-based resource synchronization in multi-node data pipelines and sampling metrics of a data pipeline.

### BRIEF SUMMARY

The subject disclosure provides for systems and methods for managing data pipelines. One aspect of the present disclosure relates to a method for need-based resource synchronization in multi-node data pipelines. The method may include determining a resource need of a consumer in a data pipeline. The method may include propagating the resource need of the consumer throughout the data pipeline to each handler in the data pipeline. The method may include receiving data from a data source at each handler in the data pipeline based at least in part on the resource need of the consumer that was determined. The method may include processing the data from the data source at each handler in the data pipeline based at least in part on the resource need of the consumer that was determined.

Another aspect of the present disclosure relates to a system configured for need-based resource synchronization in multi-node data pipelines. The system may include one or more hardware processors configured by machine-readable instructions. The processor(s) may be configured to determine a resource need of a consumer in a data pipeline. The processor(s) may be configured to propagate the resource need of the consumer throughout the data pipeline to each handler in the data pipeline. The processor(s) may be configured to receive data from a data source at each handler in the data pipeline based at least in part on the resource need of the consumer that was determined. The processor(s) may be configured to process the data from the data source at each handler in the data pipeline based at least in part on the resource need of the consumer that was determined.

Yet another aspect of the present disclosure relates to a non-transient computer-readable storage medium having instructions embodied thereon, the instructions being executable by one or more processors to perform a method for need-based resource synchronization in multi-node data pipelines. The method may include determining a resource need of a consumer in a data pipeline. The method may include propagating the resource need of the consumer throughout the data pipeline to each handler in the data pipeline. The method may include receiving data from a data source at each handler in the data pipeline based at least in part on the resource need of the consumer that was determined. The method may include processing the data from the data source at each handler in the data pipeline based at least in part on the resource need of the consumer that was determined.

Still another aspect of the present disclosure relates to a system configured for need-based resource synchronization in multi-node data pipelines. The system may include means for determining a resource need of a consumer in a data pipeline. The system may include means for propagating the resource need of the consumer throughout the data pipeline to each handler in the data pipeline. The system may include means for receiving data from a data source at each handler in the data pipeline based at least in part on the resource need of the consumer that was determined. The system may include means for processing the data from the data source at each handler in the data pipeline based at least in part on the resource need of the consumer that was determined.

One aspect of the present disclosure relates to a method for sampling metrics of a data pipeline. The method may include determining whether a user is included in a sample of a data pipeline. The method may include calculating one hundred percent of a user graph when it is determined that the user is included in the sample. The method may include, when it is determined that the user is not included in the sample, calculating one hundred percent of an unsampled graph of the user with a sampled part of the user graph left uncalculated. The method may include labelling a node of the data pipeline as sampled in order to have the node and metrics of the node sampled. The method may include labelling an event of the data pipeline as sampled in order to have the event and metrics of the event sampled. The method may include determining that only sampled nodes and/or events depend from other sampled nodes and/or events.

Another aspect of the present disclosure relates to a system configured for sampling metrics of a data pipeline. The system may include one or more hardware processors configured by machine-readable instructions. The processor(s) may be configured to determine whether a user is included in a sample of a data pipeline. The processor(s) may be configured to calculate one hundred percent of a user graph when it is determined that the user is included in the sample. The processor(s) may be configured to, when it is determined that the user is not included in the sample, calculate one hundred percent of an unsampled graph of the user with a sampled part of the user graph left uncalculated. The processor(s) may be configured to label a node of the data pipeline as sampled in order to have the node and metrics of the node sampled. The processor(s) may be configured to label an event of the data pipeline as sampled in order to have the event and metrics of the event sampled. The processor(s) may be configured to determine that only sampled nodes and/or events depend from other sampled nodes and/or events.

Yet another aspect of the present disclosure relates to a non-transient computer-readable storage medium having instructions embodied thereon, the instructions being executable by one or more processors to perform a method for sampling metrics of a data pipeline. The method may include determining whether a user is included in a sample of a data pipeline. The method may include calculating one hundred percent of a user graph when it is determined that the user is included in the sample. The method may include, when it is determined that the user is not included in the sample, calculating one hundred percent of an unsampled graph of the user with a sampled part of the user graph left uncalculated. The method may include labelling a node of the data pipeline as sampled in order to have the node and metrics of the node sampled. The method may include labelling an event of the data pipeline as sampled in order to have the event and metrics of the event sampled. The method may include determining that only sampled nodes and/or events depend from other sampled nodes and/or events.

Still another aspect of the present disclosure relates to a system configured for sampling metrics of a data pipeline. The system may include means for determining whether a user is included in a sample of a data pipeline. The system may include means for calculating one hundred percent of a user graph when it is determined that the user is included in the sample. The system may include means for, when it is determined that the user is not included in the sample, calculating one hundred percent of an unsampled graph of the user with a sampled part of the user graph left uncalculated. The system may include means for labelling a node of the data pipeline as sampled in order to have the node and metrics of the node sampled. The system may include means for labelling an event of the data pipeline as sampled in order to have the event and metrics of the event sampled. The system may include means for determining that only sampled nodes and/or events depend from other sampled nodes and/or events.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates optimal resource usage in a pipeline through need-based synchronization, according to certain aspects of the disclosure.

FIG. 2 illustrates a system configured for need-based resource synchronization in multi-node data pipelines, according to certain aspects of the disclosure.

FIG. 3 illustrates an example flow diagram for need-based resource synchronization in multi-node data pipelines, according to certain aspects of the disclosure.

FIG. 4 illustrates a system configured for sampling metrics of a data pipeline, according to certain aspects of the disclosure.

FIG. 5 illustrates an example flow diagram for sampling metrics of a data pipeline, according to certain aspects of the disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Modern businesses (e.g., a social media platform company) have lots of data, which can strain or exceed available compute and storage resources. Data down sampling can be introduced to lessen the load. Improper data sampling can lead to bad data. Within complex systems, it may be difficult to sufficiently implement, maintain, and/or tune sampling for both business needs and efficiency. Traditionally, business need may win out and sampling strategies may be implemented at the beginning and end of a pipeline. In conventional approaches, these sampling strategies are rarely tuned further due to the underlying complexity, required work, and driving priority to protect data for the business need. As such, unnecessary costs may be incurred in data handling characterized by the difference between the needs of a data pipeline's consumers and the offerings of a data pipeline's data source.

According to some implementations, the term “handler” may include a “node” in a data pipeline. A handler may include one or more of a software service, a process, and/or a piece of hardware. A handler may include an entity that does some amount of processing and/or transmittance of data in the pipeline.

According to some implementations, the term “consumer” includes a given handler's downstream handlers. In other words, a consumer includes the handlers the given handler passes data to.

According to some implementations, the term “upstreams” includes the handlers and/or data sources that pass data to a given handler.

In exemplary implementations, the needs of a pipeline's Consumers may be propagated throughout the pipeline. An individual handler may be tuned to only transmit as much data as necessary to satisfy the needs of its consumers. Only the data that is necessary to satisfy the business needs of consumers may be handled and thus only incur costs for data handling as is necessary for business needs.

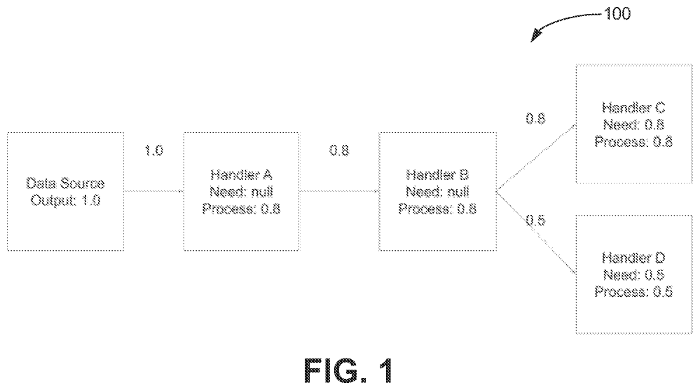

FIG. 1 illustrates optimal resource usage in a pipeline 100 through need-based synchronization, according to certain aspects of the disclosure. The data pipeline may include handlers A, B, C, and D. In pipeline 100, handlers C and D may set their need to 0.8 and 0.5, respectively. In some implementations, given that these are the only two handlers to set a Need in the pipeline and because they are positioned at the end of the pipeline, every other node that handles data for these Consumers need only handle up to 0.8 (the largest downstream need of all handlers) of all samples that enter the pipeline. By synchronizing the resource needs across nodes in the system, bytes on wire and processing costs may be saved at every step of the pipeline while continuing to support business needs.

Exemplary implementations may include need synchronization between some or all handlers in a data pipeline. An individual handler may register with its surrounding handlers and broker correct data usage. The individual handler may register its need with upstreams. The individual handler may read in the needs of its consumers. The individual handler may broker the correct amount of data it needs to process and pass to each consumer based on the rate of its upstreams and the needs of its consumers. Some implementations may include a process of synchronization up and down the pipeline as each handler brokers its correct data usage based on the data its receiving from its upstreams and that it needs to pass to its consumers.

Exemplary implementations may include resource management. In some implementations, an individual handler processes just the data it needs to process and only passes the data it needs to pass to its consumers to fulfill their needs. Some or all handlers in the pipeline may process in a similar manner. Some implementations may include a master node that deals with the need-based synchronization of the pipeline. Each handler may drop data down to the level it has agreed to process and pass that to each consumer.

These techniques could be applied to data-intensive workflows including logging, analytics, and/or other workflows. Companies dealing with huge amounts of logs, data, and analyses will likely need to invest in such capabilities at some point as their data outgrows their ability to scale physical hardware. Companies are likely spending huge amounts of resources handling unnecessary data in their system. Additionally, logging-focused companies would likely need to invest in such technology to scale at the rate of their customers.

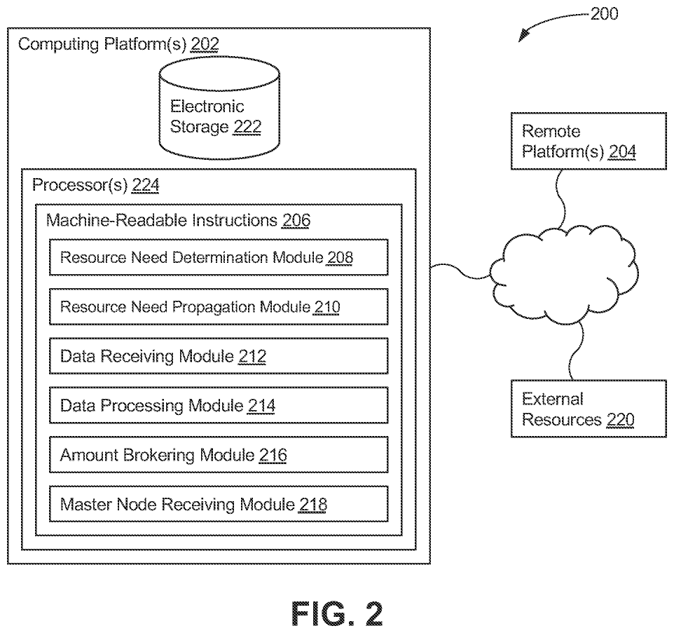

FIG. 2 illustrates a system 200 configured for need-based resource synchronization in multi-node data pipelines, according to certain aspects of the disclosure. In some implementations, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of resource need determination module 208, resource need propagation module 210, data receiving module 212, data processing module 214, amount brokering module 216, master node receiving module 218, and/or other instruction modules.

Resource need determination module 208 may be configured to determine a resource need of a consumer in a data pipeline. The resource need may be based at least in part on a maximum need of one consumer of a plurality of consumers in the data pipeline. Each handler may register the resource need with nodes upstream from it. Each handler may read the resource need. Each handler may process and/or pass data from/to its consumers based on the resource need.

The data pipeline may be for at least one of logging and/or analytics.

Resource need propagation module 210 may be configured to propagate the resource need of the consumer throughout the data pipeline to each handler in the data pipeline. Data receiving module 212 may be configured to receive data from a data source at each handler in the data pipeline based at least in part on the resource need of the consumer that was determined.

Data processing module 214 may be configured to process the data from the data source at each handler in the data pipeline based at least in part on the resource need of the consumer that was determined.

Amount brokering module 216 may be configured to, for each handler, broker a correct amount of data needed by the handler to process and pass to each consumer based on a rate of those upstream from it and the resource need.

Master node receiving module 218 may be configured to receive at a master node the resource need of the pipeline.

In some implementations, each consumer may process data provided upstream from a handler.

In some implementations, computing platform(s) 202, remote platform(s) 204, and/or external resources 220 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 220 may be operatively linked via some other communication media.

A given remote platform 204 may include one or more processors configured to execute computer program modules. The computer program modules may be configured to enable an expert or user associated with the given remote platform 204 to interface with system 200 and/or external resources 220, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 220 may include sources of information outside of system 200, external entities participating with system 200, and/or other resources. In some implementations, some or all of the functionality attributed herein to external resources 220 may be provided by resources included in system 200.

Computing platform(s) 202 may include electronic storage 222, one or more processors 224, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 222 may comprise non-transitory storage media that electronically stores information. The electronic storage media of electronic storage 222 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 222 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 222 may include one or more virtual storage resources (e.g., cloud storage, a virtual private network, and/or other virtual storage resources). Electronic storage 222 may store software algorithms, information determined by processor(s) 224, information received from computing platform(s) 202, information received from remote platform(s) 204, and/or other information that enables computing platform(s) 202 to function as described herein.

Processor(s) 224 may be configured to provide information processing capabilities in computing platform(s) 202. As such, processor(s) 224 may include one or more of a digital processor, an analog processor, a digital circuit designed to process information, an analog circuit designed to process information, a state machine, and/or other mechanisms for electronically processing information. Although processor(s) 224 is shown in FIG. 2 as a single entity, this is for illustrative purposes only. In some implementations, processor(s) 224 may include a plurality of processing units. These processing units may be physically located within the same device, or processor(s) 224 may represent processing functionality of a plurality of devices operating in coordination. Processor(s) 224 may be configured to execute modules 208, 210, 212, 214, 216, and/or 218, and/or other modules. Processor(s) 224 may be configured to execute modules 208, 210, 212, 214, 216, and/or 218, and/or other modules by software; hardware; firmware; some combination of software, hardware, and/or firmware; and/or other mechanisms for configuring processing capabilities on processor(s) 224. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, and/or 218 are illustrated in FIG. 2 as being implemented within a single processing unit, in implementations in which processor(s) 224 includes multiple processing units, one or more of modules 208, 210, 212, 214, 216, and/or 218 may be implemented remotely from the other modules. The description of the functionality provided by the different modules 208, 210, 212, 214, 216, and/or 218 described below is for illustrative purposes, and is not intended to be limiting, as any of modules 208, 210, 212, 214, 216, and/or 218 may provide more or less functionality than is described. For example, one or more of modules 208, 210, 212, 214, 216, and/or 218 may be eliminated, and some or all of its functionality may be provided by other ones of modules 208, 210, 212, 214, 216, and/or 218. As another example, processor(s) 224 may be configured to execute one or more additional modules that may perform some or all of the functionality attributed below to one of modules 208, 210, 212, 214, 216, and/or 218.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

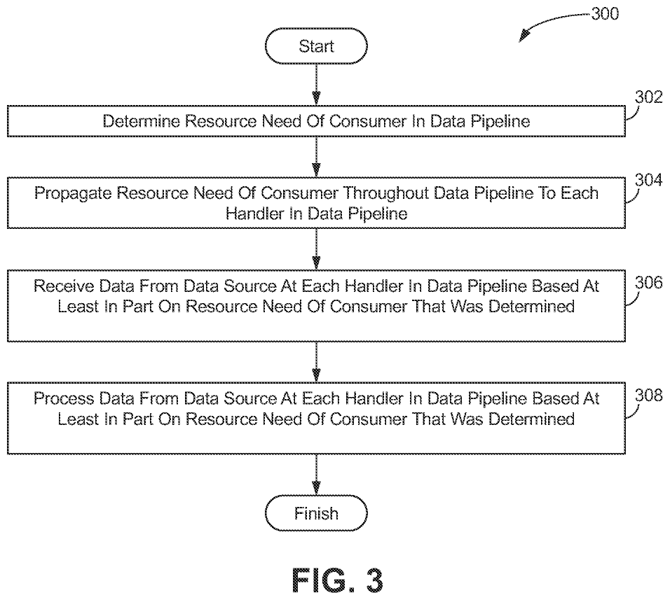

FIG. 3 illustrates an example flow diagram (e.g., process 300) for need-based resource synchronization in multi-node data pipelines, according to certain aspects of the disclosure. For explanatory purposes, the example process 300 is described herein with reference to FIGS. 1 and 2. Further for explanatory purposes, the steps of the example process 300 are described herein as occurring in serial, or linearly. However, multiple instances of the example process 300 may occur in parallel. For purposes of explanation of the subject technology, the process 300 will be discussed in reference to FIGS. 1 and 2.

At step 302, the process 300 may include determining a resource need of a consumer in a data pipeline. At step 304, the process 300 may include propagating the resource need of the consumer throughout the data pipeline to each handler in the data pipeline. At step 306, the process 300 may include receiving data from a data source at each handler in the data pipeline based at least in part on the resource need of the consumer that was determined. At step 308, the process 300 may include processing the data from the data source at each handler in the data pipeline based at least in part on the resource need of the consumer that was determined.

For example, as described above in relation to FIGS. 1 and 2, at step 302, the process 300 may include determining a resource need of a consumer in a data pipeline, through resource need determination module 208. At step 304, the process 300 may include propagating the resource need of the consumer throughout the data pipeline to each handler in the data pipeline, through resource need propagation module 210. At step 306, the process 300 may include receiving data from a data source at each handler in the data pipeline based at least in part on the resource need of the consumer that was determined, through data receiving module 212. At step 308, the process 300 may include processing the data from the data source at each handler in the data pipeline based at least in part on the resource need of the consumer that was determined, through data processing module 214.

According to an aspect, the resource need is based at least in part on a maximum need of one consumer of a plurality of consumers in the data pipeline.

According to an aspect, each consumer processes data provided upstream from a handler.

According to an aspect, each handler registers the resource need with nodes upstream from it.

According to an aspect, each handler reads the resource need.

According to an aspect, the process 300 further includes, for each handler, brokering a correct amount of data needed by the handler to process and pass to each consumer based on a rate of those upstream from it and the resource need.

According to an aspect, each handler process and/or passes data from/to its consumers based on the resource need.

According to an aspect, the process 300 further comprises receiving at a master node the resource need of the pipeline.

According to an aspect, the data pipeline is for at least one of logging and/or analytics.

Exemplary implementations include a system to protect the validity of external metrics that must have 100% of data in a pipeline with sampled metrics. Some implementations may sample video metrics (e.g., by user) at certain layers in order to save on storage and compute. However, some video metrics in the pipeline may need 100% of data for 100% of users. Due to the coexistence of 100% external metrics and <100% sampled metric, some implementations validate the correctness of external metrics with respect to this sampling.

It is understood that the herein described user-sampling paradigm(s) may work for any system that calculates entity-based metric computations (e.g., user-based metrics, key-based metric computations, etc.). For example, the described paradigm(s) may work for any key-based metric computation. According to aspects, key-based metric computations may include, but are not limited to, keying on a device ID, IP address, etc., an identifier (e.g., a key) that metrics are being computed for.

A pipeline may include a graph of events (e.g., logs), nodes, and/or metrics. Events, nodes, and/or metrics may be, by default, calculated at 100%. In some implementations, for a metric to be computed correctly at 100%, the dependency graph of the node in which it is calculated must be calculated at 100%.

Exemplary implementations may perform user-based sampling. In some implementations, if a user is in the sample, then 100% of their graph may fire. In some implementations, if a user is not in the sample, then 100% of the unsampled graph is calculated with the sampled part of the graph left uncalculated. The uncalculated part is where efficiency gains may be made. A node may label itself as sampled in order to have itself and its metrics sampled. An event may label itself as sampled (though sampling may happen outside of the pipeline). For example, an event may be a log. In some implementations, only sampled nodes may depend on other sampled nodes/events.

Sampling may be done bit by bit. As more metrics are migrated to new data sources, exemplary implementations may allow for progressive sampling (e.g., it can be added bit by bit without breaking components of the pipeline). Some implementations may allow nodes and events to mark themselves as sampled to ensuring that no unsampled node relies on a sampled node/event in its calculation tree. In other words, only sampled nodes may depend on sampled nodes/events. Exemplary implementations provide progressive sampling within the pipeline that still protects the calculations of nodes that need to be calculated at 100%.

Sampled elements may include pipeline nodes and/or metrics. If in the sample, nodes will calculate as normal. If not in the sample, nodes may skip calculation completely. Sampling may include creating a sampling node that can be relied on by any nodes that want sampling. In some implementations, each node may implement its own skipping logic. Sampling may include creating a sampling schema config option that would allow a node to configure itself to have sampling and sampling would be codegenned in. Sampling may be done under-the-hood by using various methods.

If all events, nodes, and metrics are calculated at 100%, external metric denotation may be unnecessary. If a node is not a sampled node, then it may need to be a node calculated at 100% and suitable for an external metric. To ensure that a given metric is being calculated based off of 100% of its graph, the dependency graph may be traversed for each non-sampled-node and ensure it contains no sampled elements (e.g., nodes or events).

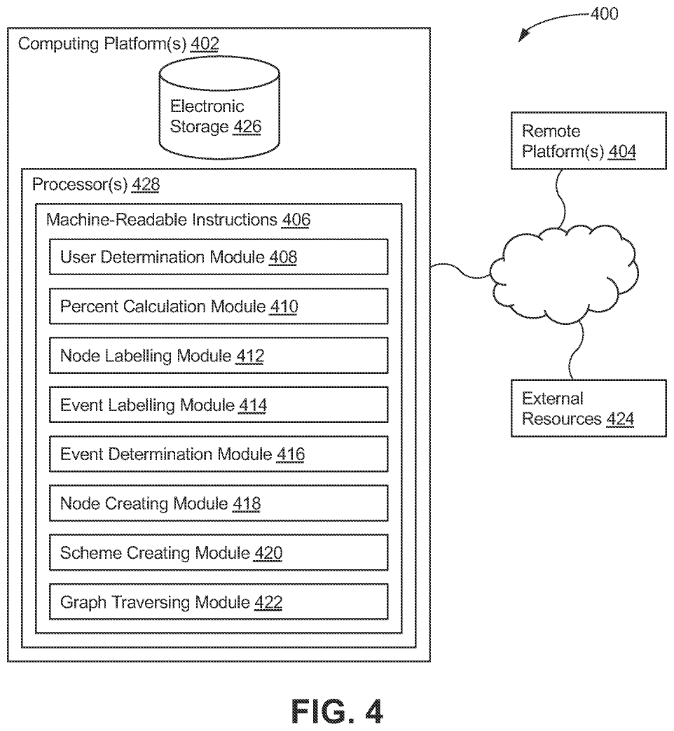

FIG. 4 illustrates a system 400 configured for sampling metrics of a data pipeline, according to certain aspects of the disclosure. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of user determination module 408, percent calculation module 410, node labelling module 412, event labelling module 414, event determination module 416, node creating module 418, scheme creating module 420, graph traversing module 422, and/or other instruction modules.

User determination module 408 may be configured to determine whether a user is included in a sample of a data pipeline. Sampled nodes will calculate as normal if it may be determined that the user is included in the sample. Sampled nodes will skip calculation if it may be determined that the user is not included in the sample.

Percent calculation module 410 may be configured to calculate one hundred percent of a user graph when it is determined that the user is included in the sample.

Percent calculation module 410 may be configured to, when it is determined that the user is not included in the sample, calculate one hundred percent of an unsampled graph of the user with a sampled part of the user graph left uncalculated. The calculating may include progressive sampling of data.

Node labelling module 412 may be configured to label a node of the data pipeline as sampled in order to have the node and metrics of the node sampled.

Event labelling module 414 may be configured to label an event of the data pipeline as sampled in order to have the event and metrics of the event sampled.

Event determination module 416 may be configured to determine that only sampled nodes and/or events depend from other sampled nodes and/or events.

Node creating module 418 may be configured to create a sampling node that may be relied on by any nodes that want sampling.

Scheme creating module 420 may be configured to create a sampling scheme that allows a node to configure itself to have sampling integrated.

Graph traversing module 422 may be configured to traverse a dependency graph for each non-sampled node to ensure it contains no sampled elements.

In some implementations, metrics may be sampled bit by bit. In some implementations, only sampled nodes may depend from the other sampled nodes. In some implementations, only sampled events may depend from other sampled events. In some implementations, the events may be sampled at a listener level. For example, a listener may be a log handler.

In some implementations, computing platform(s) 402, remote platform(s) 404, and/or external resources 424 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 424 may be operatively linked via some other communication media.

A given remote platform 404 may include one or more processors configured to execute computer program modules. The computer program modules may be configured to enable an expert or user associated with the given remote platform 404 to interface with system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 424 may include sources of information outside of system 400, external entities participating with system 400, and/or other resources. In some implementations, some or all of the functionality attributed herein to external resources 424 may be provided by resources included in system 400.

Computing platform(s) 402 may include electronic storage 426, one or more processors 428, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 426 may comprise non-transitory storage media that electronically stores information. The electronic storage media of electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426 may include one or more virtual storage resources (e.g., cloud storage, a virtual private network, and/or other virtual storage resources). Electronic storage 426 may store software algorithms, information determined by processor(s) 428, information received from computing platform(s) 402, information received from remote platform(s) 404, and/or other information that enables computing platform(s) 402 to function as described herein.

Processor(s) 428 may be configured to provide information processing capabilities in computing platform(s) 402. As such, processor(s) 428 may include one or more of a digital processor, an analog processor, a digital circuit designed to process information, an analog circuit designed to process information, a state machine, and/or other mechanisms for electronically processing information. Although processor(s) 428 is shown in FIG. 4 as a single entity, this is for illustrative purposes only. In some implementations, processor(s) 428 may include a plurality of processing units. These processing units may be physically located within the same device, or processor(s) 428 may represent processing functionality of a plurality of devices operating in coordination. Processor(s) 428 may be configured to execute modules 408, 410, 412, 414, 416, 418, 420, and/or 422, and/or other modules. Processor(s) 428 may be configured to execute modules 408, 410, 412, 414, 416, 418, 420, and/or 422, and/or other modules by software; hardware; firmware; some combination of software, hardware, and/or firmware; and/or other mechanisms for configuring processing capabilities on processor(s) 428. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, 418, 420, and/or 422 are illustrated in FIG. 4 as being implemented within a single processing unit, in implementations in which processor(s) 428 includes multiple processing units, one or more of modules 408, 410, 412, 414, 416, 418, 420, and/or 422 may be implemented remotely from the other modules. The description of the functionality provided by the different modules 408, 410, 412, 414, 416, 418, 420, and/or 422 described below is for illustrative purposes, and is not intended to be limiting, as any of modules 408, 410, 412, 414, 416, 418, 420, and/or 422 may provide more or less functionality than is described. For example, one or more of modules 408, 410, 412, 414, 416, 418, 420, and/or 422 may be eliminated, and some or all of its functionality may be provided by other ones of modules 408, 410, 412, 414, 416, 418, 420, and/or 422. As another example, processor(s) 428 may be configured to execute one or more additional modules that may perform some or all of the functionality attributed below to one of modules 408, 410, 412, 414, 416, 418, 420, and/or 422.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

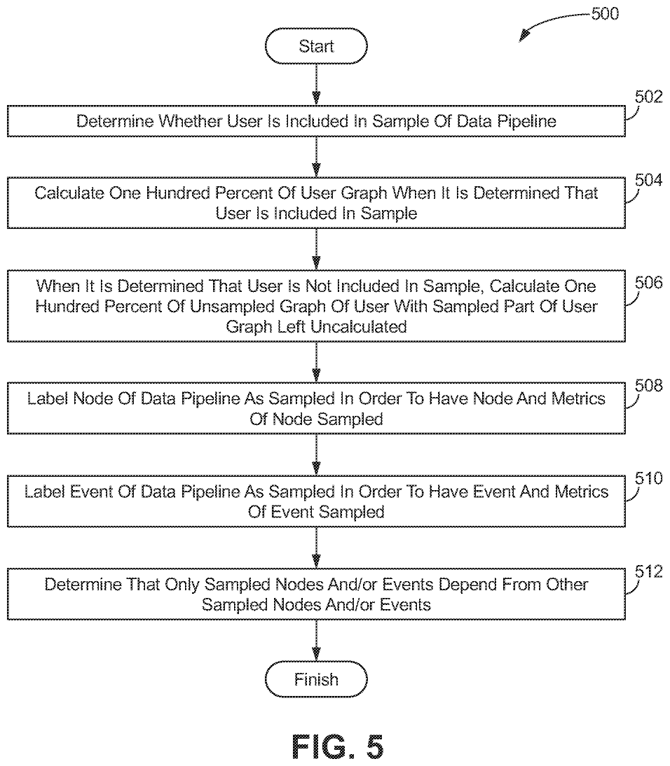

FIG. 5 illustrates an example flow diagram (e.g., process 500) for sampling metrics of a data pipeline, according to certain aspects of the disclosure. For explanatory purposes, the example process 500 is described herein with reference to FIG. 4. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to FIG. 4.

At step 502, the process 500 may include determining whether a user is included in a sample of a data pipeline. At step 504, the process 500 may include calculating one hundred percent of a user graph when it is determined that the user is included in the sample. At step 506, the process 500 may include when it is determined that the user is not included in the sample, calculating one hundred percent of an unsampled graph of the user with a sampled part of the user graph left uncalculated. At step 508, the process 500 may include labelling a node of the data pipeline as sampled in order to have the node and metrics of the node sampled. At step 510, the process 500 may include labelling an event (e.g., a log) of the data pipeline as sampled in order to have the event and metrics of the event sampled. At step 512, the process 500 may include determining that only sampled nodes and/or events depend from other sampled nodes and/or events.

For example, as described above in relation to FIG. 4, at step 502, the process 500 may include determining whether a user is included in a sample of a data pipeline, through user determination module 408. At step 504, the process 500 may include calculating one hundred percent of a user graph when it is determined that the user is included in the sample, through percent calculation module 410. At step 506, the process 500 may include when it is determined that the user is not included in the sample, calculating one hundred percent of an unsampled graph of the user with a sampled part of the user graph left uncalculated, through percent calculation module 410. At step 508, the process 500 may include labelling a node of the data pipeline as sampled in order to have the node and metrics of the node sampled, through node labelling module 412. At step 510, the process 500 may include labelling an event of the data pipeline as sampled in order to have the event and metrics of the event sampled, through event labelling module 414. At step 512, the process 500 may include determining that only sampled nodes and/or events depend from other sampled nodes and/or events, through event determination module 416.

According to an aspect, metrics are sampled bit by bit.

According to an aspect, the calculating comprises progressive sampling of data.

According to an aspect, only sampled nodes may depend from the other sampled nodes.

According to an aspect, only sampled events may depend from other sampled events.

According to an aspect, sampled nodes will calculate as normal if it is determined that the user is included in the sample.

According to an aspect, sampled nodes will skip calculation if it is determined that the user is not included in the sample.

According to an aspect, the process 500 further comprises creating a sampling node that may be relied on by any nodes that want sampling.

According to an aspect, the process 500 further comprises creating a sampling scheme that allows a node to configure itself to have sampling integrated.

According to an aspect, the events are sampled at a listener (e.g., a log handler) level.

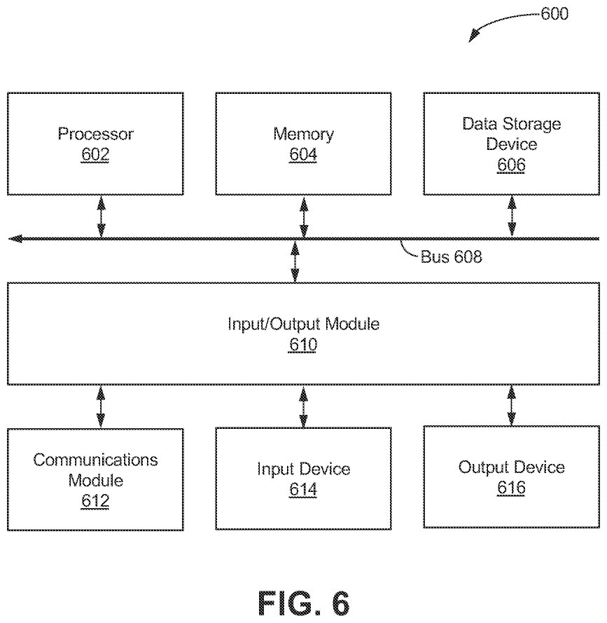

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as a LCD (liquid crystal display) monitor, for displaying information to the user.

According to one aspect of the present disclosure, the above-described gaming systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads game data and provides a game, information may be read from the game data and stored in a memory device, such as the memory 604. Additionally, data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for need-based resource synchronization in multi-node data pipelines, comprising:
determining a resource need of a consumer in a data pipeline;
propagating the resource need of the consumer throughout the data pipeline to each handler in the data pipeline;
receiving data from a data source at each handler in the data pipeline based at least in part on the resource need of the consumer that was determined; and
processing the data from the data source at each handler in the data pipeline based at least in part on the resource need of the consumer that was determined.

2. The method of claim 1, wherein the resource need is based at least in part on a maximum need of one consumer of a plurality of consumers in the data pipeline.

3. The method of claim 1, wherein each consumer processes data provided upstream from a handler.

4. The method of claim 1, wherein each handler registers the resource need with nodes upstream from it.

5. The method of claim 1, wherein each handler reads the resource need.

6. The method of claim 1, further comprising:
for each handler, brokering a correct amount of data needed by the handler to process and pass to each consumer based on a rate of those upstream from it and the resource need.

7. The method of claim 1, wherein each handler processes and/or passes data from/to its consumers based on the resource need.

8. The method of claim 1, further comprising:
receiving at a master node the resource need of the pipeline.

9. The method of claim 1, wherein the data pipeline is for at least one of logging and/or analytics.

10. A system configured for need-based resource synchronization in multi-node data pipelines, the system comprising:
one or more hardware processors configured by machine-readable instructions to:
determine a resource need of a consumer in a data pipeline;
propagate the resource need of the consumer throughout the data pipeline to each handler in the data pipeline;
receive data from a data source at each handler in the data pipeline based at least in part on the resource need of the consumer that was determined; and
process the data from the data source at each handler in the data pipeline based at least in part on the resource need of the consumer that was determined.

11. The system of claim 10, wherein the resource need is based at least in part on a maximum need of one consumer of a plurality of consumers in the data pipeline.

12. The system of claim 10, wherein each consumer processes data provided upstream from a handler.

13. The system of claim 10, wherein each handler registers the resource need with nodes upstream from it.

14. The system of claim 10, wherein each handler reads the resource need.

15. The system of claim 10, wherein the one or more hardware processors are further configured by machine-readable instructions to:
for each handler, broker a correct amount of data needed by the handler to process and pass to each consumer based on a rate of those upstream from it and the resource need.

16. The system of claim 10, wherein each handler processes and/or passes data from/to its consumers based on the resource need.

17. The system of claim 10, wherein the one or more hardware processors are further configured by machine-readable instructions to:
receive at a master node the resource need of the pipeline.

18. The system of claim 10, wherein the data pipeline is for at least one of logging and/or analytics.

19. A non-transient computer-readable storage medium having instructions embodied thereon, the instructions being executable by one or more processors to perform a method for need-based resource synchronization in multi-node data pipelines, the method comprising:
determining a resource need of a consumer in a data pipeline;
propagating the resource need of the consumer throughout the data pipeline to each handler in the data pipeline;
receiving data from a data source at each handler in the data pipeline based at least in part on the resource need of the consumer that was determined; and
processing the data from the data source at each handler in the data pipeline based at least in part on the resource need of the consumer that was determined.

20. The computer-readable storage medium of claim 19, wherein the resource need is based at least in part on a maximum need of one consumer of a plurality of consumers in the data pipeline.
